(19) United States
(12) Patent Application Publication
(10) Pub. No.: US 2004/0197740 A1
(43) Pub. Date: Oct. 7, 2004

(54) Method for obtaining an impression for producing a dental prosthesis and instrumentation architecture therefor

(76) Inventor: Benaddi Amar, Lille (FR)

Correspondence Address: GOTTLIEB RACKMAN & REISMAN PC, 270 MADISON AVENUE, 8TH FLOOR, NEW YORK, NY, 100160601

(21) Appl. No.: 10/477,224

(22) PCT Filed: May 6, 2002
(86) PCT No.: PCT/FR02/01545

(30) Foreign Application Priority Data
May 7, 2001 (FR) 01/06067

(51) Int. Cl. A61C 9/00

(52) U.S. Cl. 433/214

(57) ABSTRACT

The invention concerns a digital method for obtaining an impression. The impression is a radio-digital impression obtained by a scanner-type X-ray generating apparatus. A file of digital data is generated and, in a preferred embodiment, transmitted by telematic channel to a prosthesis manufacturing centre. The latter is equipped with a micro-computer controlling, on the basis of the digital data and a specific program, machine-tools for producing prostheses and/or master casts. The invention also concerns an instrumentation architecture for implementing said method comprising a scanner-type X-ray generator.

The invention relates to a method for taking an impression for use in preparing a dental prosthesis and to the apparatus assembly for its embodiment.

The invention relates to a method of taking a digital impression for use in preparing a dental prosthesis.

The invention also relates to an apparatus assembly for the embodiment of such a method.

For the scope of the invention, the term “dental prosthesis” has to be taken in the most general sense. It relates to all kinds of prostheses in the strict sense of the word, such as crowns, onlays, veneers etc. as well as all other similar devices.

In the prior art, the preparation of a dental prosthesis is carried out in the conventional manner according the steps as recalled hereunder.

The dentist takes an impression of the patient's buccal cavity after treatment. The principle of taking this impression known as “in the mouth” is perfectly similar to that of ancient Egypt: impressions were done with clay. According to current technology, silicone, plastic materials or alginates, a material similar to plaster, are generally used.

After the impression has been taken, it is cast into plaster as soon as possible to preserve the three-dimensional features of the patient's buccal cavity. The dental laboratory will subsequently endeavour to reconstruct the latter in plaster. This plaster model is of the utmost importance as all subsequent steps in preparing the prosthesis both depend and hinge on this model called the “master model”.

Usually, this “master model” has to undergo several adjustments, and in particular, has to be cut at precise spots to obtain portions of the so-called “die” model. This “die” will be used as a support to produce the metal reinforcement of a crown or cupula via the lost wax technique. The next step is to provide it with a layer. After processing the cupula, except for cases of wholly metal crowns that are more or less complete after the layering stage, the prosthesis technician will successively mount either resin or porcelain in the form of ceramic layers that are baked in a specially equipped oven. This porcelain layering requires approximately an hour, and this is to be compared with all the preceding steps that usually take several days in conventional laboratories.

From the moment the impression is taken in the mouth up until the application of the porcelain cover layers, it is obvious that there are necessarily errors inherent to each of these steps. This is a recognised source of problems between the dental practitioner and the prosthesis technician. It is often the case that the one considers the other to be responsible for any incorrectly fitted prosthesis; the prosthesis technician will claim that the work has been undertaken based the impression, and, therefore, any problem that may arise is due to the impression itself; the dental practitioner will reply that the impression was accurate and that if such were not the case, no work should have been carried out on an impression deemed unsatisfactory.

Even when the prosthesis is correctly fitted in the mouth, it will always be necessary, in practice, to make adjustments, however, small. This proves that the conventional means of production for dental prostheses, in prior art, presents points that need to be reviewed.

It is for this reason and to attempt to overcome the aforesaid drawbacks, that systems of producing mechanised prostheses according to a technique so called “CAD” (Computer aided design) have been developed. These systems are based on optical or laser scanning, or a combination of both, or even by using a sensing device, of the “master model” provided by the prosthesis technician. The “master model” has been produced in the conventional way, always from an impression taken in the mouth. It therefore continues to present, at least in part, the drawbacks inherent in this technique.

There exists another method, of great interest in theory, but it can only be used for a very limited number of prostheses; single crown, veneers, on-lays (a filling which replaces the conventional amalgam filling known as a “mercury filling”). This method consists of taking an optical impression directly in the mouth and subsequently producing these types of prostheses by means of CAD, hence a machined piece of monochrome porcelain.

However, a problem remains. In almost all cases, the optical impression in the mouth does not provide good results. This is due to several factors: saliva secreted by the patient, a mouth not opened wide enough etc. The dental practitioner is thus forced to carry out a conventional impression in silicone or other material and pour it in plaster, and subsequently carry out the optical impression to produce the crown. These characteristics show the limits of this system.

As a result of the aforesaid, the techniques of producing dental prosthesis according to prior art, remain very empirical, as the process requires implementing a number of steps that cannot be completely controlled at each stage of their production.

Although more recent methods used in prosthesis laboratories are very impressive, thanks to the scanning technology used on the master models prior to producing the crown cupula and machining according to CAD techniques, they remain however dependent upon the impressions obtained from the mouth by the dental practitioner. They are neither wholly or not partly free from the drawbacks linked to these steps in the production.

The object of the invention is to provide a digital method for obtaining an impression for use in preparing a dental prosthesis attempting to offset the drawbacks of the prior art, some of which have been recalled above.

Another particular object of the invention is to provide such a method wherein a dental practitioner is no longer required to take the impression, and its cupula into plaster is no longer the resort of the prosthesis technician; these are the main sources of inaccuracies involving time-consuming repetitions and finally high costs.

Pursuant to the first important feature of the invention, a radio-digital impression is taken using X-rays.

More precisely, once treatment is finished, the dental practitioner is able to take digital impressions by using either a medical scanner if he/she works in a treatment centre where one is available for other purposes, or a pseudo scanner (for example, the NEWTOM brand, registered trademark). This sort of apparatus can be installed in a standard sized room, 3 by 3 metres, or even less. It is therefore possible to install it a majority of dental surgeries. More generally, an X-ray generating device is to be used i.e. providing for tomography.

Pursuant to the method of the invention, a digital file showing the teeth ready to be crowned, can be obtained directly at the advantageous scale of 1-1. The impression can no longer be distorted, as is the case for the methods according to prior art, when silicone or alginates are used. It is also no longer necessary to cast the impression in plaster. A study model can be obtained via stereolithography after converting the file formats into an appropriate format, advantageously into a format such as “.STL”.

The method is, however, compatible with the prosthesis technician's working practices. After receiving the study model produced as outlined above, the technician may continue working as beforehand to produce the cupula and subsequently the crown.

All potential problems between the dental practitioner and the prosthesis technician as to the origin of the responsibility of the error are thus eliminated as the radio-digital impression does not depend on the dental practitioner's skills and the model produced by the stereolithography mirrors exactly the patient's mouth. Errors, therefore, if they occur, can only be attributable to the successive steps to obtain the cupula.

Pursuant to another advantageous feature of the present invention, whereby removing these drawbacks, it is possible to transmit these radio-digital files directly to a CAD machining center. A conversion of the digital files to this device's format allows for the “short circuiting” of the master model scanning step, a step that is always necessary in prior art.

A system of digital data processing with memorised programmes, for example, a micro-computer, works advantageously with customized prosthesis design software and receives the aforementioned digital files. This allows for the required prosthesis to be designed and pilots the milling device in order to produce the prosthesis. The latter may be either, as indicated above, a metal crown, a mono-chromic porcelain crown, a mono-chromic veneer, or an on-lay etc. These prostheses can be shipped directly to the dental practitioner.

In the case of a cupula, either metal or porcelain, this must be sent to the prosthesis technician beforehand so as to customize the tooth by mounting a porcelain cover; this usually takes an hour to complete, compared with a lapse of several days as is currently the case.

Using X-rays presents a number of advantages, among which:

They provide a high level of precision; for dental prostheses the level of precision obtained is situated between 30 and 50 micrometers;

The new radiological instruments produce digital images, from which digital files can be generated directly;

It is therefore no longer necessary to use development devices and to use development liquids harmful to the environment, and this besides the economic costs of such methods;

The images are taken extremely rapidly, sometimes in the space of a few seconds, contrary to the conventional way of taking impressions which last at least a few minutes with the added risk of having to restart the process if the patient's impressions are not wholly satisfactory or if the latter feels nauseous due to the products used in the process; and

Once the acquisition conditions have been set, the radiological images can be reproduced and the quality of the image does not depend on the person who took it.

It should be noted that the X-ray doses have no harmful effect on patients given the technology used and the acquisition time of a few seconds.

Finally, the X-rays do not pollute the environment and are completely harmless for the patient with the new generation of digitally controlled devices.

To sum up the above, it is to be noted that, in certain cases, there is practically no human physical manipulation between the moment when the radio-digital impression is taken and when the dental practitioner fits the prosthesis in the patient's mouth. This is particularly the case for everything involving the back part of the buccal cavity starting with the premolars. In other words, this is the case when aesthetic considerations do not dominate purely functional considerations.

On the other hand, as regards the frontal part of the mouth, the part that could be called the “smile”, the prosthesis technician may have to intervene, in particular to customize the crowns. The prosthesis technician can thus concentrate exclusively on this part of his work, the “artistic” side, and disregard all previous steps, for which he is no longer responsible. This thus represents considerable gains in time and effort for the prosthesis technician and increases the productivity of his manufacturing unit.

The main object of this invention is thus to provide a method for taking an impression in an area comprising the maxillo-facial sphere of a patient for use in preparing a prosthesis and/or a device so called the “master model”, wherein the said impression is a radio-digital impression carried out by means of a X-ray generating device of the scanner type providing a tomography, said method comprising at least subsequent steps of generating a digital data file from the said impression and the production, based on the said data contained in the said digital file, of the said prosthesis and/or the said “master model” device.

Yet another object of the present invention is an apparatus assembly for the embodiment of this method.

The invention is now described is greater detail with reference made to the attached drawings, of which:

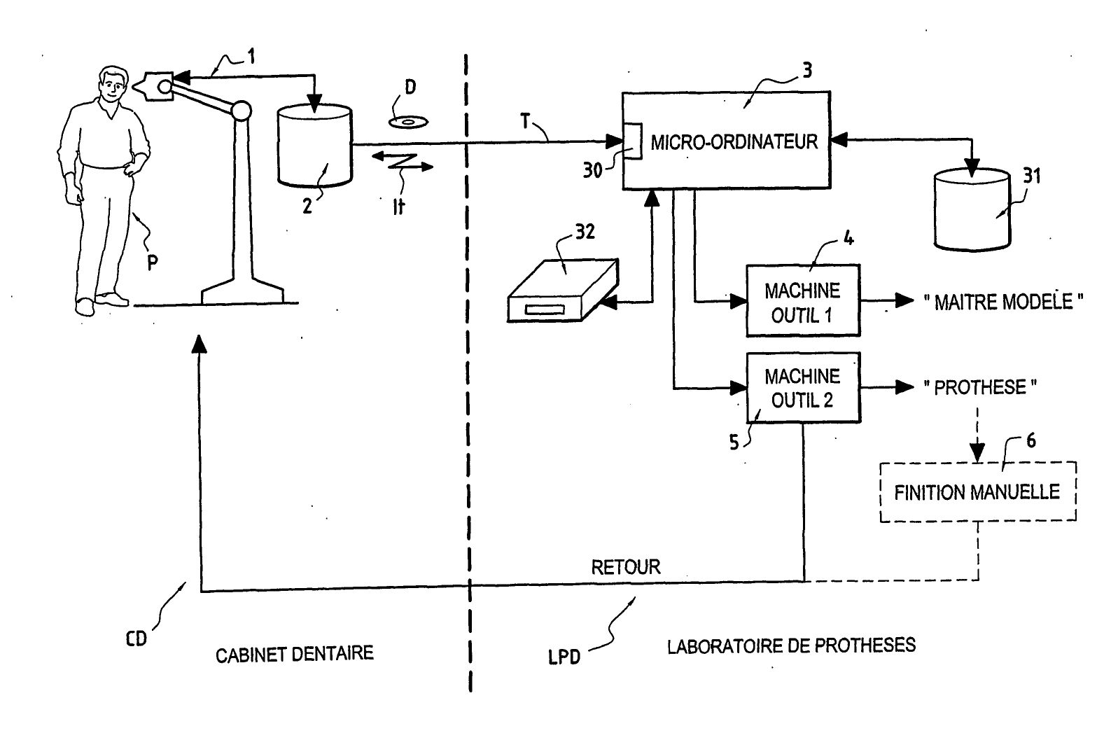

FIG. 1 is a schematic diagram depicting the main steps of the digital process of impression-taking and completion of a dental prosthesis, in a preferred form of the invention and shows the distribution of tasks between a dental surgery where the impression is taken, and a dental prosthesis manufacturing laboratory where the prosthesis is produced.

In reference to FIG. 1. the main steps of the method according to the invention implemented, a priori, in the dental surgery CD, are described first of all.

The first step, pursuant to a main feature of the invention, consists of taking a radio-digital impression of the buccal cavity of patient P once the work known as “in mouth” has been completed.

The radio-numerical impression can be performed by a dentist or dental assistant (not represented in the figure). It is done with the aid of an X-ray generating device, under general reference 1 of the medical scanner type or of the “pseudo-scanner” type, as indicated above. Such devices are well known as such. They are used in other fields of medicine. It is therefore not necessary to describe them further. Normally, the patient is directed to an adjacent room where the X-ray generating device 1 is located.

The second step comprises generating a digital file 2. The digital file 2 may be advantageously obtained out of the X-ray generating device 1; this file shows the teeth, ready, for example, for a crown, preferentially on the 1-1 scale.

During a third step, digital file 2 as set up, is transmitted to the dental prosthesis manufacturing laboratory or to a dental site where such prostheses are produced, generally called a LPD. It can be transmitted by different means and in particular by the two main means described hereunder:

A first transmission mode is the datacom line, generally meaning: modem, transmission via a local network, by Internet, or by intranet linking dental surgeries and one or several dental prosthesis manufacturing laboratories, etc. This mode of transmission is depicted symbolically under the general reference It.

According to a possible second transmission mode, the file is first of all recorded on a support medium: floppy disk, tape, CD-ROM (read only, for example, “CD-R” or re-recordable such as “CD-RW”) etc. The support medium is conveyed by conventional means: letter, hand delivery etc. This mode of transmission is depicted symbolically under the general reference D.

Hereafter is a description of the main steps of the method according to the invention which is, generally speaking, undertaken in a dental prosthesis manufacturing laboratory LPD.

In a preferred embodiment, file 2 is received by a datacom transmission line T connected to a micro-computer 3, or more generally, to a digital data processing system provided with memorised programmes via a modem 30 for example. The micro-computer 3 can treat the data it receives, i.e. file 2, immediately or store it for later use in a mass storage 31. Further, it includes various conventional components both internal (processor etc) and external (peripheral devices such as screen, keyboard, mouse etc.).

These components, well known as such, have not been depicted in FIG. 1 with the exception of the recorded media reader symbolised by a floppy disk reader 32. The latter is notably used to read file 2 when the latter is recorded on a D medium. It goes without saying that the exact nature of reader 32 depends on the D medium to be read: CD-ROM, tapes etc. Several types of readers are to be advantageously provided.

The micro-computer 3 can record one or several specific programmes in the form of specialised prosthesis design software, advantageously on a hard disk: bulk storage 31. File format conversion programmes may also be advantageously implemented in micro-computer 3. These programmes allow, when required, for the conversion of the initial format of received file 2 into a format that is appropriate to command the machining centers that are to be detailed hereafter.

The file in its new format, in cooperation with the afore-mentioned specialised programmes, may command, where necessary, either the first master model machining center 4, or the second actual prosthesis machining center 5.

Two cases may arise:

The first case concerns a prosthesis known as an aesthetic prosthesis, or designed for the frontal area (teeth seen in smiling) of a patient needing treatment.

A metallic or ceramic cupula is made first of all. The cupula is in turn taken over by the prosthesis technician (not represented) who customises one or several definite teeth. This is carried out by mounting a ceramic layer, by moulding the latter, by a colour fading, by rending a certain saturation and a certain brightness.

This step is symbolised under reference 6 (manual treatment) in FIG. 1.

The second case concerns a so-called “non aesthetic” prosthesis or one designed for the back part of the patient's mouth.

The prosthesis can definitely be produced by machining (machining center 5) and shipped back directly to the dentist who sent the radio-digital files 2. In this case, there is practically no human intervention from the moment when the radio-digital impression is taken (X-ray generating device 1) to when the crown in produced.

The method according to the invention is also compatible with the traditional working methods of a dental prosthesis manufacturing laboratory. For prosthesis technicians who wish to continue working manually according to a “master model” and to carve the cupula themselves and if necessary, the final touches, it is possible on receiving the radio-digital files 2 to produce a master model via stereolithography.

Although the only detailed description so far has been of the production of the actual prostheses, in the widest sense of the term, it is, however, possible to generate additional applications and embodiments from the method of this invention. An important embodiment is the manufacturing of “master models” (machining center 4) whereby using them in the field of maxillofacial restoration, in particular, in the field of occlusodontics with the temporomandibular articulation pathology. In this case, a customised physiological articulator is created according to the needs of the patient undergoing treatment.

In the present state of the technique, the only devices to represent jaw articulation, are apparatus which try to simulate them more or less precisely and in a more or less complicated manner. The cost of such apparatus may reach several thousand francs, even several tens of thousands francs. As a non-exhaustive example, such systems are developed by FAG DENTAIRE, under the trademark “QUICK master”®.

The method according to the invention, inasmuch as it reconstructs the articulation of the two jaws and the jaws themselves, provides the means of obtaining, not just a more or less close simulation of this articulation, but the very articulation itself with all the movements that it can produce and thus constitutes in this way what have just been designated as “personalised articulators”.

This not only has applications in the field of prosthesis designs of whatever nature whatsoever, but also as regards devices, and this is an advantageous feature, that can be used in the field of occlusion restoration, in particular, as regards problems with temporomandibular articulation.

On reading the aforesaid, it can be easily noted that this invention attains all the objects fixed by the said invention.

The method according to the invention presents multiple advantages which have been recalled and in particular, the possibility of short circuiting the lengthy and costly step of scanning a “master model”.

It should be clear however, that the scope of the invention is not limited to those descriptions herein preferred by way of example, particularly with regard to FIG. 1. The dental prosthesis manufacturing laboratory can in particular, deploy more than two machining centers.

Finally, the digital examples have only been furnished to facilitate comprehension and should not be construed to limit the scope of the invention. They arise out of a technological choice within the reach of those skilled in the art. The same applies with regard to the material and components described in detail.

1-9. (canceled)

10. A method for taking an impression in an area comprising the maxillo-facial sphere of a patient for use in preparing a prosthesis and/or a device so called the “master model”, wherein the said impression is a radio-digital impression carried out by means of a X-ray generating device of the scanner type providing a tomography, said method comprising at least subsequent steps of generating a digital data file from the said impression and the production, based on the said data contained in the said digital file, of the said prosthesis and/or the said “master model” device.

11. The method as claimed in claim 10, comprising a step of recording the said digital data file on a data recording medium and transmission thereof to a dental prosthesis manufacturing laboratory to produce the said prosthesis and/or the said “master model.”

12. The method according to claim 11, comprising a step of recording the said digital data file in a digital data processing system provided with recorded programs, a step of converting the said digital data file from a first determined format to a second, under the control of a program recorded in the said data processing system provided with memorized programs, the said system further recording at least one specific program cooperating with the said digital data to controlling at least one machining center producing the said prosthesis and/or “master model” device.

13. The method as claimed in claim 10, further comprising a step of forwarding the said digital data file via a datacom network, to a dental prosthesis manufacturing laboratory to produce the said prosthesis and/or the said “master model.”

14. The method according to claim 13, comprising a step of recording the said digital data file in a digital data processing system provided with recorded programs, a step of converting the said digital data file from a first determined format to a second, under the control of a program recorded in the said data processing system provided with memorized programs, the said system further recording at least one specific program cooperating with the said digital data to controlling at least one machining center producing the said prosthesis and/or “master model” device.

15. The method according to claim 10, wherein the said prosthesis is a physiological articulator customized for the patient.

16. Apparatus assembly for method for taking an impression in an area comprising the maxillo-facial sphere of a patient for use in preparing a prosthesis and/or a device so called “master model”, comprising at least one X-ray generating device of the scanner type providing a tomography, whereby performing the said impression taking and generating a digital data file.

17. Apparatus assembly according to claim 16, comprising datacom transmission means to transmit the said digital data file to the said dental prosthesis manufacturing laboratory, to produce the said prosthesis and/or the said “master model” device.

18. Apparatus assembly according to claim 17, further comprising, in the said dental prosthesis manufacturing laboratory to produce the said prosthesis and/or the said “master model” device, a digital data processing system provided with memorized programs to receive the said digital data file and to generate commands for at least one machining center, the said commands being generated by the cooperation between the said digital data and at least one specific program memorized in the said data processing system provided with memorized programs.

19. Apparatus assembly according to claim 18, comprising at least two machining centers, a first machining center being dedicated to producing the said “master model” and a second “machining center” being dedicated for producing the said prosthesis.
